(19) United States
(12) Patent Application Publication
(10) Pub. No.: US 2008/0247263 A1
(43) Pub. Date: Oct. 9, 2008

(54) Method to Increase Production Rate of a Continuous Mixer or Extruder

(76) Inventors: Mohamed Esseghir, Monroe Township, NJ (US); Alex Kharazi, Somerset, NJ (US); Anthony C. Neubauer, Piscataway, NJ (US); Albert A. Quaranta, Sayreville, NJ (US)

Correspondence Address: Whyte Hirschboeck Dudek S.C., 555 East Wells Street, Suite 1900, Milwaukee, WI, 53202, US

(21) Appl. No.: 12/065,025

(22) PCT Filed: Aug. 2, 2006
(86) PCT No.: PCT/US2006/030122

§ 371 Date: Feb. 27, 2008

Related U.S. Application Data
(60) Provisional application No. 60/717,633, filed on Sep. 16, 2005.

(51) Int. Cl. B29C 47/10

(52) U.S. Cl. 366/76.6

(57) ABSTRACT

Compounding or extrusion rates can be increased by splitting the polymer solid feed. Melting of additional solid polymer is significantly assisted by excess enthalpy from incoming melt from a primary mixing stage. Depending on resin rheology and melting characteristics, rate increases were achieved of from up to about 55 to about 100% rate increase over the use of a single feed at the same rotor speed. The net result is a decrease in the overall SEI (specific energy input to the polymer) and thus melt temperatures.

### BACKGROUND OF THE INVENTION

This invention relates to processing with continuous mixers or extruders, and, more specifically, to increasing the production rate of such continuous mixers or extruders.

The production rate of an extrusion or compounding production line is frequently limited by the capacity of the extruder or continuous mixers. Solid-fed, continuous mixers and extruders generally run partially full and the volumetric melt pumping capacity of the screws is rarely achieved. The production rate is generally limited (given adequate ancillary equipment) by machine power, issues related to solid feeding, product quality or combinations thereof. For example, the production rate of resins with high melt viscosities is typically limited by the machine power. In comparison, the production rate of resins having low melt viscosities is typically limited by issues related to solids conveying. In some cases, such as in reactive extrusion and mixing, the product quality may also limit production rate due to related factors including polymer melt temperature and residence time. Melt temperature control in large production equipment is also another challenge, as extruder cooling becomes more difficult as machine size increases. Scaling up to larger machines provides deeper screw channels and lower cooling surface to volume ratios. Thus, larger machines have both a longer heat flow path (between the center of the molten mass and the closest heat transfer surface) and relatively less heat transfer surface area compared to smaller units. In combination with the low thermal conductivity of polymers, these differences in large and small machines result in the rate of heat generation by viscous dissipation being much higher than the rate of heat removal via barrel or screw cooling in large, production scale machines. For this reason, once the polymer is melted temperature control is hard to achieve.

Consequently, methods to increase the production rate of extruders and continuous mixers and methods to provide improved temperature control are highly desired by the polymer processing industry.

### BRIEF SUMMARY OF THE INVENTION

In one embodiment, the invention is a method for increasing the production rate of a continuous mixer or extruder. The method comprises: operating a continuous mixer or extruder at a given screw speed, the mixer or extruder having: (i) a first inlet port adapted to accept solid feed material; (ii) at least one second inlet port downstream of the first inlet port, the second inlet port adapted to accept solid feed material; (iii) at least one rotatable internal rotor or screw which can be operated at, at least one rotational speed; introducing a solid polymeric thermoplastic material into the extruder or mixer through the first inlet port at a first feed rate; introducing the solid polymeric thermoplastic material into the mixer or extruder through the second inlet port at a second feed rate; such that the total feed rate, which is the sum of the first feed rate and the second feed rate, is greater than a maximum feed rate on the same mixer or extruder operated at the same screw speed when the same solid polymeric material is introduced solely through the first inlet port, wherein the maximum feed rate is limited by power requirements of the mixer or extruder.

In another embodiment, the invention is a method for controlling the output melt temperature of a continuous mixer or extruder, the method comprising: operating a continuous mixer or extruder at a given screw speed, the mixer or extruder having: (i) a first inlet port adapted to accept solid feed material; (ii) at least one second inlet port downstream of the first inlet port, the second inlet port adapted to accept solid feed material; (iii) at least one rotatable internal rotor or screw which can be operated at, at least one rotational speed, and, (iv) at least one outlet; introducing a first stream of a solid polymeric thermoplastic material into the mixer or extruder through the first inlet port at a first feed rate; melting the first stream of solid polymeric thermoplastic material in the mixer or extruder to form a first molten mass; introducing a second stream of the solid polymeric thermoplastic material into the mixer or extruder through the second inlet port at a second feed rate such that the second stream of a solid polymeric thermoplastic material is in intimate contact with the first molten mass; melting the second stream of solid polymeric thermoplastic material at least partially by thermal energy transferred from the first molten mass, such that the molten polymeric material of the second stream combines with the first molten mass to form a total molten mass; expelling the total molten mass through the outlet, the total molten mass having an outlet melt temperature, wherein the first feed rate and the second feed rate are selected to obtain a desired outlet melt temperature.

In a further embodiment, the invention is a method for increasing the production rate of a continuous mixer or extruder. The method comprises: operating a continuous mixer or extruder at a given screw speed, the mixer or extruder having: (i) a first inlet port adapted to accept solid feed material; (ii) at least one second inlet port downstream of the first inlet port, the second inlet port adapted to accept solid feed material; (iii) at least one rotatable internal rotor or screw which can be operated at, at least one rotational speed; introducing a first stream of a solid polymeric thermoplastic material to the extruder or mixer through the first inlet port at a first feed rate; introducing a second stream of the solid polymeric thermoplastic material to the mixer or extruder through the second inlet port at a second feed rate; wherein the first feed rate and the second feed rate are selected to achieve a total feed rate, determined by adding the first feed rate and the second feed rate, that is greater than a maximum comparative feed rate on the same mixer or extruder operated at the same screw speed when the same solid polymeric material is introduced solely through the first inlet port, wherein the maximum comparative feed rate is limited by pumping limitations of the mixer or extruder.

Various other features, objects and advantages of the present invention will be made apparent from the following detailed description.

### DETAILED DESCRIPTION OF THE INVENTION

The inventors have found that when using a dual feed, dual stage mixer to process highly viscous resins, splitting the solid polymer feed provides better utilization of the available mechanical energy, which, in turn, allows higher production rates to be achieved compared to using a conventional feeding protocol. The same split feed concept was applied successfully to a low viscosity resin where compounding rates are limited by solid conveying rather than machine power. By judicious adjustment of the feed streams, the process provided a better control of the polymer melt temperature.

Generally, the process of the invention is a compounding or extrusion process. Compounding can be effected in a conventional continuous mixer or in a conventional extruder adapted for the process, and the terms “compounding” and “extrusion” are used in this specification interchangeably. Likewise, “continuous mixer,” and “extruder” are also used interchangeably herein. Generally, the composition is prepared in a continuous mixer and then pelletized using a pelletizer attachment or an extruder adapted for pelletizing. Both the continuous mixer, as the name implies, and the extruder, in effect, have melting and mixing zones although the various sections of each are known to those skilled in the art by different names. In the present case, the important zones are the first and second mixing zones. The first mixing zone can be considered to be a melt/mixing zone since the resin is melted in this zone. In the second zone, the molten resin from the first mixing zone contributes substantially to the melting of the added solid resin. A lower level of mechanical energy is required in the second mixing zone to maintain the mixture in the molten state while it is being mixed, thus resulting in an overall lowering of the product temperature. An important feature in the second mixing zone is the venting means, which can be provided by one or more ports. The venting takes place prior to mixer discharge, and is believed to reduce the possibility of return gases, and improve the feeding of the additional resin to the second mixing zone, thus allowing production at increased rates.

The inventive process can be carried out in various types of continuous mixers and extruders, such as, single or twin screw extruders or other polymer processing devices. The device requires inlet and outlet zones, and at least two injection zones, each zone containing an injection port. Using more than two injection ports to further split the polymer feed is within the scope of this invention. In addition, heating means are provided to maintain the resin in a molten state and provide some control throughout the extrusion process. Likewise, mixing means are also required to keep the resin in a state of agitation for the same period. The mixing can be accomplished by a threaded screw, an impeller, or other device incorporated into the body of the mixer or extruder. Twin screw extruders or continuous mixers are preferred due to more efficient mixing in comparison with a single screw device.

A typical extruder has a first hopper at its upstream end and a die at its downstream end. Additional feed hoppers may be located along the barrel downstream from the first hopper. The hopper feeds into a barrel, which contains a screw. At the downstream end, between the end of the screw and die, a screen pack and a breaker plate may be included. The screw portion of the extruder is considered to be divided up into three sections, the feed section, the compression section, and the metering section, and two zones, the back heat zone and the front heat zone, the sections and zones running from upstream to downstream. If the extruder has more than one barrel, the barrels are connected in series. The length to diameter ratio of each barrel is in the range of about 5:1 to 30:1. It will be understood that the inlet, outlet, and injection zones as used in this specification are not necessarily coextensive with those zones, which are named as parts of a typical extruder. Rather, the inlet, outlet, and injection zones can be located in one barrel or in several barrels. They are simply areas that are of sufficient length and have adequate heating and mixing means to effect the melting, mixing, grafting, or devolatilization to be accomplished in the particular area or zone. Thus, off-the-shelf equipment can be easily converted to provide the required zones.

Various types of continuous mixers and extruders such as a Brabender™ mixer, Banbury™ mixer, a roll mill, a Buss™ co-kneader, a biaxial screw kneading extruder, and single or twin screw extruders can be adapted to carry out the process of the invention. A description of a conventional extruder can be found in U.S. Pat. No. 4,857,600. In addition to melt/mixing, the extruder can be used to coat a glass fiber or a copper wire or a core of glass fibers or copper wires. An example of co-extrusion and an extruder therefore can be found in U.S. Pat. No. 5,575,965.

Preferably, the continuous mixer or extruder is a new generation “long” continuous compounding mixers such as the Kobe™ LCM™ mixer or the Farrel™ ADVEX-D™ mixer. The characteristics of these mixer designs are that they are typically 10 L/D long and are configured in two stage mixing chambers. The two stages are separated by an adjustable gate/orifice. The beginning of the second stage is usually provided with a “decompression zone” and a vent port. The rotor configuration and chamber-dam configuration are manipulated to the effect that the two stages can be considered to be two independent mixing zones.

All compounding lines involving melting of solid polymers can be retrofitted to implement new process to increase rates and improve melt temperature control. These include twin rotor continuous mixers (type Farrel™, Kobe™, JSW™) as well as twin screw extruders (Type K™ W&P etc.). Additional modifications would be needed to make use of the new process in cases where compounding rates are limited by other factors such as residence time to complete a reaction or pressure limits from downstream equipment.

### EXAMPLES

In the following examples, melt index (MI) was measured by ASTM-D1238 at 190° C. and 2.16 kg and density was measured by ASTM D-792.

The inventive concept was tested on a dual stage Farrel™ mixer, in which the vent port was used as a second feed port, to achieve the results shown in Tables 1 and 2. Experiments were conducted on a two-stage Farrel™ 4″ FCM™ fitted with two feeding ports and two-stage mixing rotors. Each rotor has a first stage comprising a helical forwarding feeding section followed by a mixing section. The second stage is the second stage portion of the rotor was originally designed to improve venting and degassing as well as additional mixing before polymer discharge.

As shown in Table 1, with a high viscosity resin (DGM-1810 Polyethylene (0.918 g/cm³ density, 1.0 g/10 min. MI, 121.2° C. melting point))—this is a representative intermediate gas phase resin—when a single feed port was used, the maximum production rate was 775 lb/hr (Run #2) at which the maximum mixer power was reached. Run #2 was characterized by a high specific energy input (SEI) (0.1623 hp·hr/lb) and a high indicated polymer melt temperature of 310° C. By gradually increasing the second feed, and adjusting the feed ratio, could reach equivalent compounding rates at much lower SEI and melt temperature (Runs #8 and #9). Indeed, the melt temperature for Runs #8 and #9 were about 80° C. to 90° C. less than the melt temperature for Run #2. Further increasing the feed rates in both stages resulted in an overall higher rates at lower SEI and melt temperature than found in Run #2 (Runs #12 to #15). Rate increases, over Run #2, of about 10, 16, 23, 29, 42, 48, and 55% are demonstrated in Runs #9, 10, 11, 12, 13, 14, and 15, respectively. Therefore, with split feeding and judicious balance between the two feed streams, the total achievable production rate (Run #15) was 1200 lb/hr, or 54.8% rate increase, at the mixer power limit and improved melt temperature control was obtained.

As shown in Table 2, with a low viscosity resin (DGL-5280 Polyethylene (0.952 g/cm³ density, 80 g/10 min MI, 127.8° C. melting point)),—this is a representative intermediate gas phase resin—when a single feed port was used, the maximum production rate was 900 lb/hr at which feed flooding occurred (RUN #16). With split feeding and judicious balance between the two feed streams, a total production rate of 1800 lb/hr (Run #25) was achieved, (100% rate increase). The new rate limit was caused by feed flooding at both feed ports, i.e., maximum pumping limit of the machine was reached.

We have shown that significant increases in compounding rates can be achieved by splitting the polymer solid feed. Melting of additional solid polymer is significantly assisted by excess enthalpy from incoming melt from a primary mixing stage. Depending on resin rheology and melting characteristics, rate increases were achieved of from up to about 55 to about 100% rate increase over the use of a single feed at the same rotor speed. The net result is a decrease in the overall SEI and thus lower melt temperatures.

In compliance with the statute, the invention has been described in language more or less specific as to structural and methodical features. It is to be understood, however, that the invention is not limited to the specific features shown and described, since the means herein disclosed comprise preferred forms of putting the invention into effect. The invention is, therefore, claimed in any of its forms or modifications within the proper scope of the appended claims appropriately interpreted in accordance with the doctrine of equivalents.

TABLE 1
PRODUCTION RATE DATA FOR A HIGH VISCOSITY RESIN

| | | Q1 Port #1 | Q2 Port #2 | Qtot | | Mixer | SEI (HP- | Mixer | Melt |
|---|---|---|---|---|---|---|---|---|---|
| Run # | Material | (lb/hr) | (lb/hr) | Total (lb/hr) | Qtot/Q1max | RPM | hr/lb) | Amps | Temp (C.) |
| 1 | DGM-1810 | 600 | 0 | 600 | 0.77 | 400 | 0.1779 | 245.7 | 316 |
| 2 | DGM-1810 | 775 | 0 | 775 | 1.00 | 400 | 0.1623 | 294.5 | 310 |
| 3 | DGM-1810 | 500 | 100 | 600 | 0.77 | 400 | 0.1691 | 224.9 | 304 |
| 4 | DGM-1810 | 400 | 200 | 600 | 0.77 | 400 | 0.1542 | 202.8 | 285 |
| 5 | DGM-1810 | 300 | 300 | 600 | 0.77 | 400 | 0.1349 | 178.9 | 259 |
| 6 | DGM-1810 | 200 | 400 | 600 | 0.77 | 400 | 0.1032 | 131.7 | 222 |
| 6A | DGM-1810 | 200 | 450 | 650 | 0.84 | 400 | 0.1022 | 145.3 | 207 |
| 8 | DGM-1810 | 300 | 450 | 750 | 0.97 | 400 | 0.1074 | 178.3 | 224 |
| 9 | DGM-1810 | 400 | 450 | 850 | 1.10 | 400 | 0.1130 | 212.6 | 234 |
| 10 | DGM-1810 | 400 | 500 | 900 | 1.16 | 400 | 0.1074 | 212.5 | 226 |
| 11 | DGM-1810 | 450 | 500 | 950 | 1.23 | 400 | 0.1092 | 237.6 | 228 |
| 12 | DGM-1810 | 500 | 500 | 1000 | 1.29 | 400 | 0.1125 | 256.0 | 235 |
| 13 | DGM-1810 | 600 | 500 | 1100 | 1.42 | 400 | 0.1123 | 282.7 | 245 |
| 14 | DGM-1810 | 600 | 550 | 1150 | 1.48 | 400 | 0.1053 | 280.2 | 229 |
| 15 | DGM-1810 | 650 | 550 | 1200 | 1.55 | 400 | 0.1073 | 297.5 | 230 |

TABLE 2
PRODUCTION RATE DATA FOR A LOW VISCOSITY RESIN

| | | Q1 Port #1 | Q2 Port #2 | Qtot Total | | Mixer | SEI (HP- | Mixer | Melt |
|---|---|---|---|---|---|---|---|---|---|
| Run # | Material | (lb/hr) | (lb/hr) | (lb/hr) | Qtot/Q1max | RPM | hr/lb) | Amps | Temp (C.) |
| 1 | DGL-5280 | 900 | 0 | 900 | 1.00 | 400 | 0.0863 | 168.7 | 168.3 |
| 2 | DGL-5280 | 900 | 100 | 1000 | 1.11 | 400 | 0.0757 | 172.2 | 159.4 |
| 3 | DGL-5280 | 900 | 200 | 1100 | 1.22 | 400 | 0.0718 | 171.4 | 152.9 |
| 4 | DGL-5280 | 900 | 300 | 1200 | 1.33 | 400 | 0.0707 | 181.4 | 146.7 |
| 5 | DGL-5280 | 900 | 400 | 1300 | 1.44 | 400 | 0.0669 | 188.3 | 144.9 |
| 6 | DGL-5280 | 900 | 500 | 1400 | 1.56 | 400 | 0.0642 | 199.6 | 144.0 |
| 7 | DGL-5280 | 900 | 600 | 1500 | 1.67 | 400 | 0.0598 | 198.8 | 147.1 |
| 8 | DGL-5280 | 900 | 700 | 1600 | 1.78 | 400 | 0.0588 | 202.1 | 150.5 |
| 9 | DGL-5280 | 900 | 800 | 1700 | 1.89 | 400 | 0.0565 | 210.8 | 149.6 |
| 10 | DGL-5280 | 900 | 900 | 1800 | 2.00 | 400 | 0.0543 | 219.3 | 148.5 |

What is claimed is:

1. A method for increasing the production rate of a continuous mixer or extruder, the method comprising:
operating a continuous mixer or extruder at a given screw speed, the mixer or extruder having: (i) a first inlet port adapted to accept solid feed material; (ii) at least one second inlet port downstream of the first inlet port, the second inlet port adapted to accept solid feed material; (iii) at least one rotatable internal rotor or screw which can be operated at, at least one rotational speed;
introducing a first stream of a solid polymeric thermoplastic material to the extruder or mixer through the first inlet port at a first feed rate;
introducing a second stream of the solid polymeric thermoplastic material to the mixer or extruder through the second inlet port at a second feed rate;
wherein the first feed rate and the second feed rate are selected to achieve a total feed rate, determined by adding the first feed rate and the second feed rate, that is greater than a maximum comparative feed rate on the same mixer or extruder operated at the same screw speed when the same solid polymeric material is introduced solely through the first inlet port, wherein the maximum comparative feed rate is limited by power requirements of the mixer or extruder.

2. The method of claim 1 wherein the continuous mixer or extruder is a twin screw mixer or extruder.

3. The method of claim 1, wherein the total feed rate is at least about 10% greater than the maximum comparative feed rate.

4. The method of claim 1, wherein the total feed rate is at least about 20% greater than the maximum comparative feed rate.

5. The method of claim 1, wherein the total feed rate is at least about 30% greater than the maximum comparative feed rate.

6. The method of claim 1, wherein the total feed rate is at least about 40% greater than the maximum comparative feed rate.

7. The method of claim 1, wherein the total feed rate is at least about 50% greater than the maximum comparative feed rate.

8. A method for controlling the melt temperature of a continuous mixer or extruder, the method comprising:
operating a continuous mixer or extruder at a given screw speed, the mixer or extruder having: (i) a first inlet port adapted to accept solid feed material; (ii) at least one second inlet port downstream of the first inlet port, the second inlet port adapted to accept solid feed material; (iii) at least one rotatable internal rotor or screw which can be operated at, at least one rotational speed, and, (iv) at least one outlet;
introducing a first stream of a solid polymeric thermoplastic material into the mixer or extruder through the first inlet port at a first feed rate;
melting the first stream of solid polymeric thermoplastic material in the mixer or extruder to form a first molten mass;
introducing a second stream of the solid polymeric thermoplastic material into the mixer or extruder through the second inlet port at a second feed rate such that the second stream of a solid polymeric thermoplastic material is in intimate contact with the first molten mass;
melting the second stream of solid polymeric thermoplastic material at least partially by thermal energy transferred from the first molten mass, such that the molten polymeric material of the second stream combines with the first molten mass to form a total molten mass;
expelling the total molten mass through the outlet, the total molten mass having a melt temperature,
wherein the first feed rate and the second feed rate are selected to obtain a desired melt temperature.

9. The method of claim 8 wherein the melt temperature is at least 20° C. less than the melt temperature for the same resin added as a single feed stream, which is equal to the total of the first feed rate and the second feed rate, to the same mixer or extruder operating at the same screw rotational speed.

10. The method of claim 8 wherein the continuous mixer or extruder is a twin screw mixer or extruder.

11. A method for increasing the production rate of a continuous mixer or extruder, the method comprising:
operating a continuous mixer or extruder at a given screw speed, the mixer or extruder having: (i) a first inlet port adapted to accept solid feed material; (ii) at least one second inlet port downstream of the first inlet port, the second inlet port adapted to accept solid feed material; (iii) at least one rotatable internal rotor or screw which can be operated at, at least one rotational speed;
introducing a first stream of a solid polymeric thermoplastic material to the extruder or mixer through the first inlet port at a first feed rate;
introducing a second stream of the solid polymeric thermoplastic material to the mixer or extruder through the second inlet port at a second feed rate;
wherein the first feed rate and the second feed rate are selected to achieve a total feed rate, determined by adding the first feed rate and the second feed rate, that is greater than a maximum comparative feed rate on the same mixer or extruder operated at the same screw speed when the same solid polymeric material is introduced solely through the first inlet port, wherein the maximum comparative feed rate is limited by pumping limitations of the mixer or extruder.

12. The process of claim 10, wherein the total feed rate is up to about 100% greater than the maximum comparative feed rate.

13. The method of claim 11 wherein the continuous mixer or extruder is a twin screw mixer or extruder.
